(19) United States
(12) Patent Application Publication
(10) Pub. No.: US 2008/0215564 A1
(43) Pub. Date: Sep. 4, 2008

(54) Query rewrite

(76) Inventor: Jon Bratseth, Trondheim (NO)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/713,444

(22) Filed: Mar. 2, 2007

(51) Int. Cl. G06F 7/00

(52) U.S. Cl. 707/5; 707/E17.017

(57) ABSTRACT

A method and apparatus for rewriting of search engine queries is provided. Queries are rewritten by applying a set of rules. The rules represent domain knowledge and can be created by developers or users outside the search engine. There are two types of rules, production rules and definitions. Production rules specify how a query can be modified. Definition type rules specify a vocabulary for matching or modification of query terms. The modified query is issued to a search engine generating more focused and relevant results.

### FIELD OF THE INVENTION

The present invention relates to improving the focus and relevancy of results returned by queries through a system for representation of domain specific knowledge.

### BACKGROUND

The approaches described in this section are approaches that could be pursued, I but not necessarily approaches that have been previously conceived or pursued. Therefore, unless otherwise indicated, it should not be assumed that any of the approaches described in this section qualify as prior art merely by virtue of their inclusion in this section.

A search engine is software (executable instructions and data) configured for searching a set of information resources. A computer executing a search engine generates search results for queries submitted to the search engine.

Search engines often run on servers, referred to herein as search engine servers. A server is a combination of integrated software components (including data) and an allocation of computational resources, such as memory, a node, and processes on a computer for executing the integrated software components, where the combination of the software and computational resources are dedicated to a particular function. In the case of a search engine server, the server is dedicated to searching for a set of information resources.

Search engines are widely used on the Internet, the World Wide Web (www, Web, WWW, etc.) and other large internetworks and information resource webs. Often, search engines are publicly accessible on servers as web sites, such as those made available by Yahoo™ and Google™ web pages, which are respectively accessible with the links (http://search.yahoo.com/) and (http://www.google.com/).

The set of information resources searched by search engines are referred to herein as documents. A document is any unit of information that may be indexed by search engine indexes, which are described below. Often a document is a file which may contain plain or formatted text, inline graphics, and other multimedia data, and hyperlinks to other documents. Documents may be static or dynamically generated.

Search engines use a search engine index (or more), also referred to herein simply as an index, to search for information. Search engine indexes can be directories, in which content is indexed more or less manually, to reflect human observation. More typically, search engine indexes are created and maintained automatically by processes referred to herein as crawlers. Crawlers explore information over the Internet, essentially continuously, looking for as many documents as they may find at locations to which the crawlers are configured to search. Crawlers may follow links from one document to another, index their content (e.g., semantically, conceptually, etc.) in a search index and summarize them in databases, typically of significant size. It is these indexes and databases that are actually searched in response to a search query.

Vertical search engines are engines that use indexes that index documents that are limited to a particular domain or particular topic. Vertical search engines may be limited in this way by, for example, configuring a crawler to search specific locations. For example, a crawler for vertical search engine for recipes may be configured to search sites and/or locations known to hold recipe documents. Another important source of data for vertical search engines are direct data feeds and direct user submissions.

The search result generated by a search engine comprises a list of documents and may contain summary information about the document. The list of documents may be ordered. To order a list of documents, a search engine may assign a rank to each document in the list. When the list is sorted by rank, a document with a relatively higher rank may be placed closer to the head of the list than a document with a relatively lower rank. A search engine may rank the documents according to relevance to the search query. Relevance is a measure of how closely the subject matter of a document matches search queries terms.

A typical query submitted to a search engine consists of a few keywords or a sentence fragment. The queries should express from the user perspective what results are expected. An approach for generating the results is word matching. Under word matching any documents containing one or more words or phrases in a query (“query terms”) are included in the results. A long inverted list of words in a query is created with pointers to which documents contain the words.

Using relevancy analysis, the long list is sorted according to the relevancy of the documents. Relevancy analysis produces several numbers for a document that are added or multiplied together to generate a rank score. The documents are then shown in the ranked according to the rank score. The goal of ranking is to rank highly the documents a user seeks with a query.

Unfortunately, word matching often fails to highly rank or even find documents a user seeks with a query. For example, in response to a query “restaurants in city of Palo Alto”, a search engine would return documents that have “city” in the content. As a result of giving too much weight to the word “city”, many documents not relevant to what the user seeks are listed and/or ranked highly in the search results.

Information implied or linguistically expressed in a query can be used to more effectively perform searches. However, to effectively use such information, a generic algorithm cannot be used because each potential domain possesses a unique language and/or vocabulary. For example, a search for restaurants in the city of Chicago will have a different vocabulary from a search for albums by a certain artist in an online music store. If the search domain or fields are known, such information may be used to customize the query, and the ranking algorithms. The customization will limit a query search and generate more relevant results and rankings. There is clearly a need to be able to effectively represent domain knowledge to extract as much information as possible from a query, and to use the domain knowledge to affect ranking of results.

### DESCRIPTION OF THE DRAWINGS

The present invention is illustrated by way of example, and not by way of limitation, in the figures of the accompanying drawings and in which like reference numerals refer to similar elements and in which:

FIG. 1 is a query rewrite system diagram, according to an embodiment of the present invention.

FIG. 2 is a table of songs and their associated information, according to an embodiment of the present invention.

FIG. 3 is an example file containing a set of rules used to represent domain knowledge, according to an embodiment of the present invention.

FIG. 4 is an example file containing a listing of albums and artists, according to an embodiment of the present invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

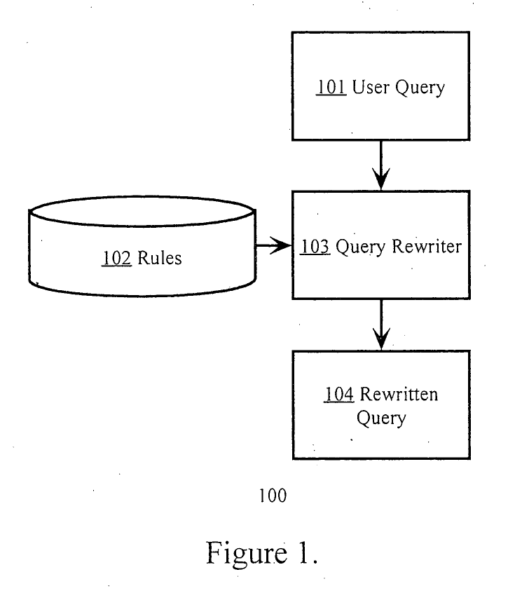

An embodiment of the invention presented herein is illustrated in FIG. 1. The query rewrite system 100 takes as input a user query 101. The query is passed to a query rewriter 103. The query rewriter 103 is coupled to a database of rules 102. The database of rules 102 contains rule bases. Individual rule bases can contain a plurality of rules that represent knowledge for a particular domain. The rules in a rule base are applied to the query in sequence to generate a rewritten query 104. The rewritten query is then passed to a search engine. The query rewriter 103 and database of rules 102 can be implemented as an integrated component of the search engine, a standalone application or a part of the client application or any combination of thereof. In an embodiment, the rule-base can be non-native to the search engine i.e. in addition to the rule base being created by search engine developers it can be created by anyone outside the search engine development team that developed and released the search engine as a product.

The rewritten query 104 is often able to retrieve fewer results with greater focus on what the user seeks with a query, as explained in greater detail below. An embodiment of the present invention is illustrated in an example in which a database of rules 102 is used by a query rewriter 103 to rewrite a query.

Rules can be used to represent domain knowledge. According to an embodiment, there are at least two types of rules, production rules and definitions. A production rule consists of two parts; a matching condition and an action. The matching condition specifies the pattern an input must match. If the matching condition is met, the rule will perform the, specified action. A definition type rule also consists of two parts, a variable name and a set of values the variable represents.

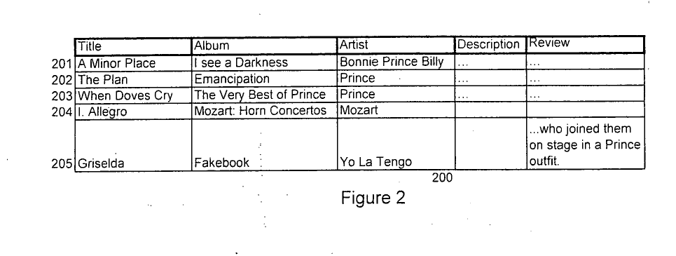

Rule generation for a particular rule base is readily demonstrated in the context of a database of songs FIG. 2. The database 200 contains the following fields: title, album, artist, description, review. There are 5 songs 201-205. All the fields are indexed to the same default index. The fields are also individually indexed by separate indexes (not shown). The default index is used for searches which do not specify a particular index. A particular index to use for a query may be, for example, specified within the query by using the syntax indexname:word.

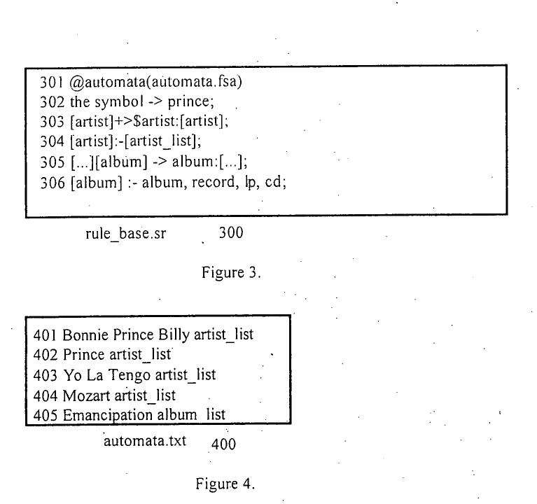

FIG. 3 represents an example rule base that is used by the query rewriter 103. In an embodiment, the rule base is generated by a domain expert. The domain expert can examine hypothetical queries and develop production and definition rules based on the examination. An example query is “The Symbol”, in it a hypothetical user wants to find works by a specific artist. The query, as is, does not return any results because the songs are indexed using the artists other name “Prince”. This fact is domain knowledge that may be exploited to rewrite queries using rules in rule base 300.

The production rule 302 stipulates a matching condition to find occurrences of “The Symbol” and an action to replace all occurrences of “The Symbol” by “Prince” in queries. However this can have unintended consequences. A search for “Prince” can bring up obscure songs done by composers that have “Prince” in their title or songs named “Prince” or songs where “Prince” is mentioned in the description or review. For example in the table of FIG. I it would bring up songs by Yo La Tengo 205, Bonnie Prince Billy 201, as well as Prince 201, 202. Noting that the search most frequently refers to songs by the artist Prince, additional production rule may be used to more specifically rewrite a query:

Prince →artist:Prince;

The production rule is interpreted as replacing an occurrence of “Prince” in a query with the term “artist:Prince”, which specifies to search through the “artist” index instead of the default index.

However, if implemented, the above production rule may be too specific and disqualify too many songs. Songs by artists other than Prince are excluded by searching only for Prince. A mechanism is provided herein to represent the domain knowledge that a certain term occurring in a certain context is to be given more weight but is not the exclusive factor to be given weight when searching for songs. In the current example, queries containing “Prince” most often are seeking songs by the artist, yet there are other songs associated the term Prince in different ways. The following syntax allows the occurrence of the term Prince in the field artist to be given more weight while not excluding any weight for the occurrence of the term in other contexts.

prince +>$artist:prince;

The above production rule will replace a query for “prince” with “$artist:prince”. The syntax specifying action in the rule is interpreted as when a term “prince” is matched in the artist index, a predetermined value increment “$” is added “+>” to the rank of a match. The syntax will recall the set of songs as if no rule was applied and the query was not rewritten, yet matches of “prince” within the artist index will get ranking weight. The ranking weight will cause the search engine to order results containing the term “prince” into a more prominent listing. To make the rule generic the following syntax is used 303.

### Definition Rules

Sometimes it is desirable to create multiple matching conditions that associate to the same rule action. This creates a more concise representation of domain knowledge and improves readability of rules. Variables allow a single production rule to specify the same action for multiple matching conditions. Variables can take on a range of values. A matching condition containing a single variable is equivalent to a series of production rules that specify the same action and a matching condition that takes on every value in the range of values assigned to a variable. Definition rules are used to assign a range of values to variables. A matching condition in a production rule can also assign a value to a variable. An example definition rule follows:

[artist]:- bonie prince billy, mozart, yo la tengo,

radiohead, sufjan stevens, wilco, prince;

A term enclosed in brackets, i.e. [ ], is a variable: the variable can take on any of the set of values of the list of terms that follow.

Alternatively, the set of values can be defined in a separate text or binary file that it subsequently imported into the rule base. The text file 400 can have a format as presented in FIG. 4. Each line of the text file 400 defines the value on the left and the variable the value belongs to on the right. For example in line 402 “Prince” belongs to variable “artist_list”. The text file 400 can contain values for different variables demonstrated by 405. The text file 400 is subsequently converted into a binary object (automata.fsa). Variable definitions from automata.fsa are included in the rule base by referencing to the binary file in 301 and then assigning 304. In another embodiment, the query rewriting system 100 is integrated with thee search engine. The integration allows for definition rules to assign sets of values to variables directly from search engine indexes. It is a generalization of an artist list given in 401-404.

### Layering of Rules

As previously described, rules can be layered. The embodiment presented here illustrates this in the context of a hypothetical user explicitly searching for a song from a i particular album, for example “Emancipation album”. Since the songs typically don't contain the word “album” such queries often do not return any results. A generic production rule can be constructed to eliminate the term “album”:

[ . . . ] album →album:[ . . . ]

The matching condition for the production rule contains a variable. A variable with ellipses, i.e. [ . . . ] matches “anything”. Therefore the matching condition accepts any phrase containing any word preceding the word album. The production rule action modifies the query by removing the word “album”, specifying the index to be searched (album) and appending the actual album name which is assigned into [ . . . ] by the matching condition. For example, the query “Emancipation album”, after the above production rule is processed, is transformed to “album:Emancipation”. The term “album” in the matching condition can also have a number of synonyms, for example: cd, record, lp. The term “album” can be replaced by a second variable. Definition rule syntax is used to define the range of values [album] variable. The production and definition rules are subsequently layered 305, 306.

Query rewriter 103 parses and then applies rules to a query. According to an embodiment, the rules are applied using a backtracking algorithm. It facilitates application developers and end users with very little training in software code development to create simple rules to encode what they know about their domain. For example. knowledge such as “restaurant in city name” can be represented. It is also possible to generate higher order rules that take as input results generated by simpler rules to create an even more refined query. The higher order rules can be applied in successive layers to achieve specificity. Rules are a part of a language grammar that is used to transform strings. In conventional grammar the left part of a rule, the part specifying the rule conditions have to be unique among a rule set. Backtracking allows for the left part of the rule to be the same for different rules. The algorithm picks the first matching rule and attempts to proceed with parsing. If the entire rule cannot be matched using a rule it picked earlier, the algorithm backtracks to the previous decision point, picks another branch of the decision point and resumes parsing. Using this mechanism the algorithm will explore different combinations of rules at various ambiguity points until it finds a complete or the best match. In picking which rules to try first, the algorithm can follow a simple heuristic of picking a rule that was written first. It will apply every rule as many times as it matches and then go on to the next rule. Once a rule has been processed, it will not be referenced again. This eliminates one of mechanisms that generate infinite loops. Infinite loops can arise by a later rule generating terms that are expanded by an earlier rule. Production rules take in a parameter and either change the parameter or add to it. In addition rule rewriting complex queries can be handled. Complex queries contain Boolean logic such as “AND” and “OR” statements.

### Hardware Overview

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 500, various machine-readable media are involved, for example, in providing instructions to processor 504 for execution. Such a medium may take many forms, including but not limited to, non-volatile media, volatile media, and transmission media. Non-volatile media includes, for example, optical or magnetic disks, such as storage device 5 10. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 504 for execution. For example, the instructions may initially be carried on a magnetic disk of a remote computer. The remote, computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. 100491 The received code may be executed by processor 504 as it is received, and/or stored in storage device 510, or other non-volatile storage for later execution. In this manner, computer system 500 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
applying a plurality of rules to a query, wherein each rule of a set of said plurality of rules specifies:
one or more conditions, and
an action;
wherein applying the set of rules includes transforming the query according to each rule of said subset of rules that is associated with one or more conditions that are satisfied based on the query.

2. The method of claim 1 where said plurality of rules are non-native to the search engine.

3. The method of claim 1 where said condition is represented by a variable associated with a set of values.

4. The method of claim 3 where said variable is assigned values explicitly in the said plurality of rules.

5. The method of claim 1 where said action specifies to use a particular search engine index.

6. The method of claim 1 where said rule increases ranking associated with a term.

7. The method of claim 1 where said action prevents recall of a term.

8. A machine readable storage medium carrying one or more sequences of instructions which, when executed by one or more processors, causes the one or more processors to perform the method recited in claim 1.

9. A machine readable storage medium carrying one or more sequences of instructions which, when executed by one or more processors, causes the one or more processors to perform the method recited in claim 2.

10. A machine readable storage medium carrying one or more sequences of instructions which, when executed by one or more processors, causes the one or more processors to perform the method recited in claim 3.

11. A machine readable storage medium carrying one or more sequences of instructions which, when executed by one or more processors, causes the one or more processors to perform the method recited in claim 4.

12. A machine readable storage medium carrying one or more sequences of instructions which, when executed by one or more processors, causes the one or more processors to perform the method recited in claim 5.

13. A machine readable storage medium carrying one or more sequences of instructions which, when executed by one or more processors, causes the one or more processors to perform the method recited in claim 6.

14. A machine readable storage medium carrying one or more sequences of instructions which, when executed by one or more processors, causes the one or more processors to perform the method recited in claim 7.

15. A system comprising:
a server;
a search engine residing on said server;
said server configured to apply a plurality of rules, wherein each rule of a set of said plurality of rules specifies:
one or more conditions, and
an action;
said server configured to receive a query; and
said server configured to transform the query according to each rule of said subset of rules that is associated with one or more conditions that are satisfied based on the query.

16. The system of claim 15 wherein said plurality of rules are non-native to the search engine.

17. The system of claim 15 wherein said condition is represented by a variable associated with a set of values.

18. The system of claim 17 wherein said variable is associated with values explicitly in the said plurality of rules.

19. The system of claim 15 wherein said action specifies to use a particular search engine index.

20. The system of claim 15 wherein said rule increases ranking associated with a term.

21. The system of claim 15 wherein said action prevents recall of a term.
